(19) United States
(12) Patent Application Publication
(10) Pub. No.: US 2009/0127938 A1
(43) Pub. Date: May 21, 2009

(54) LINEAR MOTOR COIL ASSEMBLY AND LINEAR MOTOR

(75) Inventors: Funda Sahin Nomaler, Eindhoven (NL); Johan Cornelis Compter, Eindhoven (NL); Ed Bos, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,818

(22) PCT Filed: Oct. 20, 2005
(86) PCT No.: PCT/IB05/53435

§ 371 Date: Apr. 24, 2007

(30) Foreign Application Priority Data
Oct. 28, 2004 (EP) 04105348.9

(51) Int. Cl. H02K 41/03

(52) U.S. Cl. 310/12

(57) ABSTRACT

An ironless linear motor (5) comprising a magnet track (53) and a coil assembly (50) operating in cooperation with said magnet track (53) and having a plurality of concentrated multi-turn coils (31 a-f, 41 a-d, 51 a-k), wherein the end windings (31_{E}) of the coils (31 a-f, 41 a-e) are substantially rounded, the coil part (31 S) between the end windings (31_{E}) is straight and the coils (31 a-f, 41a-d, 51a-k) are arranged in an overlapping manner, wherein the end windings (31E) are pressed together, is provided. The coil assembly has the advantage to be flat, thus being easy to handle, and leading to a high steepness.

The invention relates generally to coil assemblies for linear motors and linear motors using such coil assemblies.

Linear motors are mainly used in automation systems and lithography stages. They can be divided in two classes, iron-core motors and ironless motors. In the case of ironless motors, the main components are a magnet track with at least one row of permanent magnets with periodically alternating magnetic fields and a plurality of windings to which a current is applied, thus inducing a lorentz force moving both components with respect to each other. Depending on the design of the linear motor, the magnetic track can be stationary and the plurality of windings moving or vice-versa. Most ironless linear motors have a magnetic track with two parallel rows of alternating permanent magnets that is stationary, and the plurality of windings moving in between these two rows of magnets. The assembly of a plurality of windings is often called forcer. Ironless linear motors are advantageous over iron-core linear motors in achieving higher force per mover weight and cogging free output force. The latter is crucial in high precision applications.

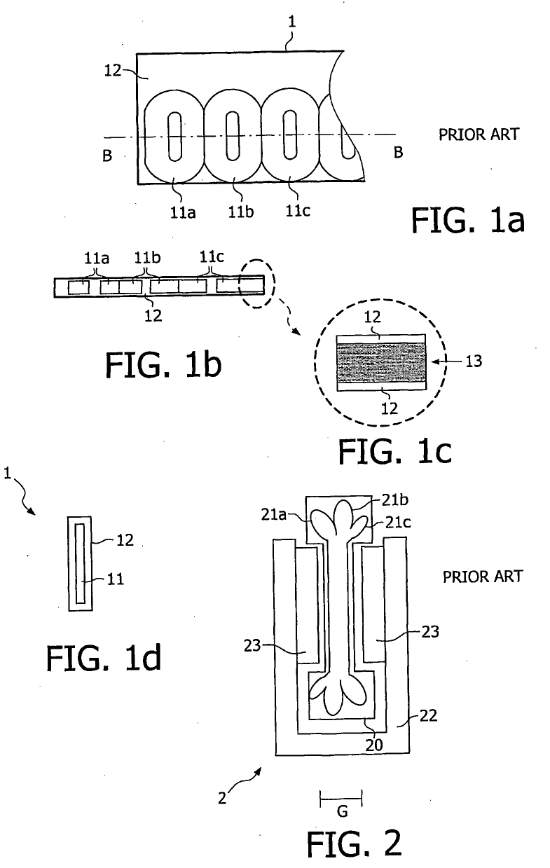

In the existing ironless linear motors on the market, two types of winding structures are implemented in the forcers. The one type of winding structures uses windings placed next to each other in an non-overlapping manner. An example is illustrated in FIG. 1a. Coils 11a-c are placed next to each other and impregnated or molded into some hardening material 12 like epoxy to be enclosed in a housing. This is also illustrated in FIG. 1b, a cut along the line B-B in FIG. 1a. The resulting coil assembly 1 is also called flat forcer, because of its flat shape (see FIGS. 1b and 1d). Often, the molding material is enforced with glass fibers.

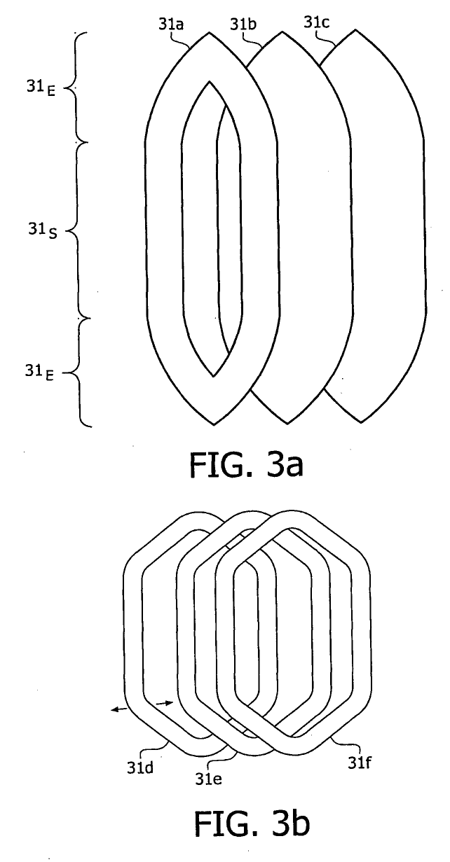

The other type of winding structure is to have overlapping windings. Due to the fact that in this winding structure the end windings of coils 21a,b,c cross each other, the assembly 20 becomes thicker at the ends with end windings directed in many different directions, as shown in FIG. 2. This winding structure is advantageous in terms of higher force production and lower harmonic distortion but is not as easy in assembly as the non-overlapping structure.

In an ironless linear motor 2 (see FIG. 2), magnets 23 are arranged in parallel rows with alternating magnetic fields and having an air gap in between on a support to form a magnetic track 22. The support is normally made of magnetic material to provide a flux return path for the permanent magnets and across the air gap. A forcer 20 made of overlapping windings is introduced in the gap G between the magnets 23 such that the middle part of the windings is placed between the magnets 23, the end windings being outside the gap G on both upper and lower sides. The coils 21a-c have different positions with respect to each other and with respect to the pitch of the magnets 23 and are connected in series and/or in parallel to get a phase of the motor, which can be single-phased or multi-phased, three-phased being most common. The end windings being oriented in many directions leads to a forcer 20 with ends larger then the middle part between the magnets 23.

The coils 11a-c of FIGS. 1a, 1b and 1d are concentrated multi-turn coils, i.e. coils made of wire, preferably copper wire. In case of non overlapping coils, they are often of orthocyclic nature. They are characterized as a number of turns (e.g. 5 to 50) in a coil with the successive turns aside and on top of each other, as is illustrated in FIG. 1c, an enlargement of the encircled detail of FIG. 1b. Concentrated multi-turn coils are to be seen in contrast to distributed windings, where the location of successive turns belonging to the same phase of the current are shifted with respect to each other, or with other words turns with another location are put in series or in parallel within one phase. Distributed windings are normally arranged in a plane extending in a straight direction and are sometimes also called linear windings. Concentrated multi-turn coils are also not to be confused with windings that have multiple turns, but only in a plane, i.e. one layer of wires aside to each other.

A lot of effort has been put into improving these basic ironless linear motors throughout the last years. One attempt has been described by X. T. Wang in U.S. Pat. No. 6,160,327. He uses distributed windings, especially of the printed circuit type, for the moving coil. He optimizes motor parameters by adjusting the length of the straight portion of the distributed winding perpendicular to the direction of the linear motion compared to the height of the linear air gap and the outside dimension of the winding.

It is an object of the invention to provide a coil assembly for an ironless linear motor with high force and ease of assembly.

In a first aspect of the present invention, a linear motor coil assembly, operable in cooperation with an associated magnet track, comprising a plurality of concentrated multi-turn coils, wherein the end windings of the coils are substantially rounded, the coil part between the end windings is straight and the coils are arranged in an overlapping manner, wherein the end windings are pressed together, is provided.

The fact of using concentrated multi-turn coils allows for production of the coils independently of the coils assembly itself in contrast to distributed windings and non-concentrated multi-turn coils. Concentrated multi-turn coils in general have been in use over decades yet, and are easily manufactured. They are readily available on the market at comparably low production cost. Besides, they are much less prone to damage than other types of windings and so easier to handle.

The substantially rounded shape of the end windings of the concentrated multi-turn coils allows to arrange the coils in an overlapping manner with the end windings being directed in basically one direction due also to pressing them, while minimizing the thickness of the end region of the overlapping windings compared to other regions of the overlapping windings. The coil assembly as a whole has a flatter shape than conventional overlapping coil assemblies. Thus, the whole coil assembly may be easily positioned between the magnets of a magnet track. Therefore, not only the middle straight part of the coils can be used for generating a linear motion, but also the end windings are well utilized. This increases even further the high force per losses already achieved by the overlapping arrangement.

In preferred embodiments, the concentrated multi-turn coils of the linear motor coil assembly are arranged in an overlapping manner such that the space filling factor in the straight part of the coil assembly is around 45% or more and/or are encapsulated in a flat housing, although the coil assembly is not ideally flat. The space filling factor gives the amount of conductor material, e.g. copper per volume of coil assembly. Placing the coils in a flat housing provides a flat forcer that can easily be handled and put between the magnets of a magnet track of a linear motor.

Preferably, the concentrated multi-turn coils have an 0-shape or hexagonal shape with rounded edges to improve as well the flatness of the coil assembly as the force produced by the linear motor using this coils assembly. Another preferred coil shape is orthogonal with rounded edges.

In a further aspect of the present invention, a linear motor comprising a magnet track and a coil assembly operating in cooperation with said magnet track and having a plurality of concentrated multi-turn coils, wherein the end windings of the coils are substantially rounded, the coil part between the end windings is straight and the coils are arranged in an overlapping manner, wherein the end windings are pressed together, is provided.

In preferred embodiments of the present invention, the concentrated multi-turn coils of the linear motor are arranged in an overlapping manner such that the space filling factor in the straight part of the coil assembly is around 45% or more and/or are encapsulated in a flat housing.

Preferably, the height of the magnets of the magnet track is at least 80% or more of the height of said concentrated multi-turn coils, thus effectively utilizing the end windings, too.

Advantageously, the end windings of the concentrated multi-turn coils are at least partly situated between the magnets of the magnet track.

The linear motor according to the invention has several advantages. The coil assembly is easy to assemble, it having a flat shape that can easily be placed in the magnet track from the top. Due to the flat shape of the coil assembly, comparably high steepness values (steepness=force²/losses) are achieved, especially compared to motors using forcers with not overlapping windings.

These and other aspects of the invention will be apparent from and elucidated with reference to the embodiments described hereinafter.

FIGS. 1a, 1b, 1c and 1d show a first type of coil assembly for a linear motor according to prior art;

FIG. 2 shows a linear motor with a second type of coil assembly according to prior art;

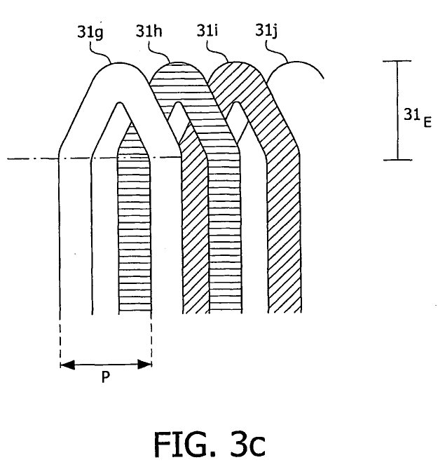

FIGS. 3a, 3b and 3c show the principle of a coil assembly according to the invention with concentrated multi-turn coils having a hexagonal shape;

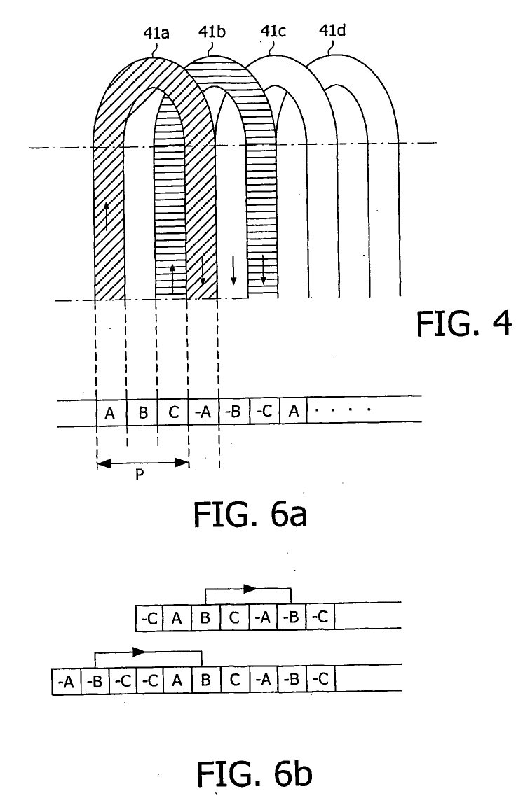

FIG. 4 shows the principle of a coil assembly according to the invention with concentrated multi-turn coils having an 0-shape;

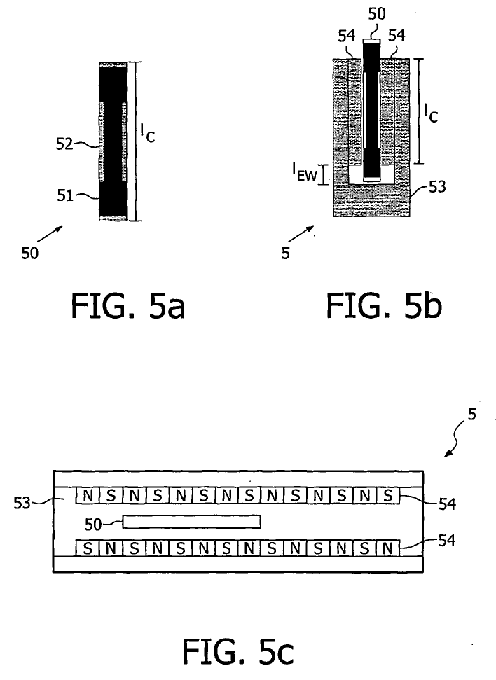

FIGS. 5a and 5d show a coil assembly according to the invention;

FIGS. 5b and 5c show a linear motor according to the invention;

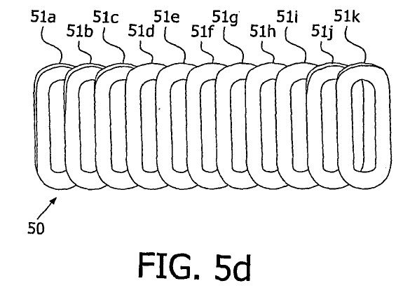

FIGS. 6a and 6b show the principle of single- and multi-layer configuration.

The concentrated multi-turn coils for the coil assembly are wound separately and then are positioned along the length of the forcer. Preferably, the coils form a multiphase structure. The overlapping arrangement may be in single or multilayer configurations. All the layers are than pressed together to obtain as much as possible filling with wire material in the direction orthogonal to the magnets, preferably a space filling factor of around 50% and more. The assembled coils are then placed in a flat formed mould cavity to be pressed into the final shape and be encapsulated by a hardening molding material. Epoxy is for example one of the commonly used materials. It is possible as well to enforce the hardening molding material with glass fibers or other non-magnetic fibers.

FIGS. 3a and 3b show two possible overlapping arrangements of concentrated multi-turn coils 31a-c, 31d-f having a substantially hexagonal shape. The coils 31a-c, 31d-f have an end winding part 31_{E} rounded between the bottom and top corners of the hexagon and a straight part 31_{S} parallel to the magnets. It will be noted, that the concentrated multi-turn coils 31a-c, 31d-f are made of a multitude of turns with the successive turns aside and on top of each other, as explained in relation with FIG. 1c. Preferably, the coil is made of copper wire or wire of other electrically conductive material, such as aluminum.

The arrangement shown in FIG. 3a is very dense packed and giving a flat shape to the assembly as a whole by having a quite large region of different coils overlapping each other. The dense packing also leads to a high space filling factor in the regions of the straight part 31_{S} parallel to the magnets of the magnet track of the ironless linear motor. The pressing of the arranged coils is done primarily for fixing the final shape, especially pressing the end windings together, before encapsulating them.

In contrast, the arrangement shown in FIG. 3b achieves an overall flat shape of the coil assembly by laying the coils in some distance to each other (the relation of distance to width being exaggerated in the drawing for better understanding) and then spreading the coils, as indicated by the arrows in FIG. 3b, by pressing. This flattens the coils assembly as a whole and leads to a higher space filling factor.

FIG. 3c partly shows overlapping concentrated multi-turn coils 31g-j having the preferred coil span, where in each coils there is space for the sides of two adjacent coils, like a side of coils 31g and a side of coils 31i in the middle of coil 31h. The width P is equal to the width of three coil sides, this being the same width as the motor pitch, or in other words, the magnetic pitch of the magnetic track.

FIG. 4 shows a coil arrangement using 0-shaped concentrated multi-turn coils 41a-d. As in FIG. 3c, the coil span is such that the middle gap of a coil provides just the space for two sides of two neighboring coils, e.g. sides of coils 41a and 41c in the middle gap of coil 41b, or sides of the coils 41b and 41d in the middle gap of coil 41c. The arrows indicate the direction of the current flowing in the coils 41a-d. Again, three adjacent sides of the same polarity are equivalent to the motor pitch viz. the magnetic pitch of the magnetic track, as is also illustrated in FIG. 6a.

FIG. 6a is a cross-sectional view of the coils shown in FIG. 4, where the phases A, −A correspond to coils 41a, 41d, the phases B, −B correspond to coils 41b and the phases C, −C correspond to coil 41c. The length P of ABC (or −A −B −C as well) is equivalent to the motor pitch.

Whereas FIG. 6a shows a single-layer configuration, FIG. 6b shows a multi-layer configuration, more specifically a double-layer configuration, where the two layers are shifted such that same phases of each layer are juxtaposed. The arrows indicate again the current flow. Instead of two layers, one could as well use three, four or more layers of coils.

FIG. 5a shows a cut through a coil assembly 50 according to the invention, its coil arrangement principle being illustrated in FIG. 5d, with overlapping concentrated multi-turn coils 51a-k in a casing 52. If one compares it with the flat forcer 1 shown in FIGS. 1a-d, one will note that the coil assembly 50 of FIG. 5 is as flat as the flat forcer 1 and shows end windings being pressed together such that they are oriented in basically the same direction. Thus, the coil assembly 50 according to the invention is as easily placed in a magnet track 53 between two rows of alternating permanent magnets 53 as a prior art flat forcer (see FIGS. 5b and 5c) and leads as well to a minimal residual air gap between flat forcer 50 and magnets 54. But it has the additional advantage of producing a higher force due to a higher space fill factor. Especially the end windings may be partially, as shown in FIG. 5b, or totally positioned between the magnets 53 of the magnet track 53 of the ironless linear motor 5 according to the invention. Preferably, the height of the magnets 1_{M} is at least 80% or more of the height of the coils 1_{C}.

The person skilled in the art will notice, that various embodiments of the linear motor are possible. One possibility is having a single coil assembly and a magnetic track with a single row of magnet, wherein the coil assembly moves and the magnetic track is stationary or vice versa. Another possibility is having a coil assembly between two rows of magnets and either the coil assembly or the magnet track moving. A further possibility is to have a magnet track being positioned between two coils assemblies. Again either coil assemblies or the magnet track is moving. There might be an extra steel plate adjacent to the coil assemblies.

The person skilled in the art will also notice, that either coil assembly or magnet track may have cooling means. Cooling channels are preferred, especially ceramic or aluminum channels, permitting liquid or air cooling.

The person skilled in the art will further notice, that the phases of the coil assembly may be energized by means of brushes or electronic commutation, i.e. without brushes. In case of electronic commutation, preferably Hall-sensors embedded to the coil assembly will be used.

Furthermore, the person skilled in the art will notice, that the width of the coil span may vary with respect to the magnetic pitch of the magnetic track, leading to an overpitch or an underpitch.

The steepness per volume of four linear motors according to the invention has been measured and compared with four linear motors as are available on the market. The steepness is defined as the ratio of the square of the coil force to the motor power loss. The continuous force can be calculated from the measured flux. To measure the flux, the phases are connected to fluxmeters and the flux-position data is recorded along the whole motor length for two phases subsequently while the forcer is moving very slowly.

TABLE 1

| | Motor | Steepness/volume (N²/Wm³) |
|---|---|---|
| no. 1 | Philips No-1 | 5.72 × 10⁵ |
| no. 2 | Philips No-1 Bis | 5.70 × 10⁵ |
| no. 3 | comparative motor 1 | 3.65 × 10⁵ |
| no. 4 | comparative motor 2 | 3.04 × 10⁵ |
| no. 5 | Philips No-2 | 6.63 × 10⁵ |
| no. 6 | Philips No-2 Bis | 6.48 × 10⁵ |
| no. 7 | comparative motor 3 | 4.07 × 10⁵ |
| no. 8 | comparative motor 4 | 4.06 × 10⁵ |

The motors 1, 2, 5, 6 according to the invention of Table 1 had flat forcers with overlapping concentrated multi-turn coils having a basically hexagonal shape in single-layer configuration. The space filling factor in the direction orthogonal to the magnets was around 51%. The height of the magnets was above between 80% and 85% of the height of the concentrated multi-turn coils in the forcer, thus making use of part of the end windings, too

The comparative motors 3, 4, 7, 8 were motors with non-overlapping coils like shown in FIGS. 1a-c.

The motors 1 and 2 according to the invention had approximately the same dimensions as the comparative motors 3 and 4, i.e. a cross-section of around 30 mm×105 mm. The motors 5 and 6 according to the invention had approximately the same dimensions as the comparative motors 7 and 8, i.e. a cross-section of around 40 mm×125 mm. The motors 1 and 2 as well as 5 and 6 differed in that the motors 1 and 5 were longer than the motors 2 and 6.

To be able to compare the motors independently form their dimensions, the steepness per volume was calculated. As it is seen from Table 1, the motors according to the invention are around a factor 1.6 better than the motors as are available in the market in terms of the Figure of merit steepness per volume, which practically indicates how much more force can be obtained from a volume at equal power loss generation. The major reason behind the relatively high steepness of the motors according to the invention is the flat overlapping winding structure used in the forcers according to the invention. Due to flatness and easy mounting, the end windings can be utilized. The overlapping arrangement allows for higher force capability.

It has to be pointed out, that not only the steepness per volume of the motor according to the invention was superior to the according FIGURE of the comparative motors, but also the force ripple was considerably less.

It is noted that the preferred embodiments of the coil assemblies and linear motors described herein in detail for exemplary purposes are of course subject to many different variations in structure, design, application and methodology. Because many varying and different embodiments may be made within the scope of the inventive concept herein taught, and because many modifications may be made in the embodiment herein detailed, it is to be understood that the details herein are to be interpreted as illustrative and not in a limiting sense. For example, various combinations of the features of the following dependent claims could be made with the features of the independent claim without departing from the scope of the present invention. Furthermore, any reference numerals in the claims shall not be construed as limiting scope.

### LIST OF REFERENCE NUMERALS

1 forcer
11a-c non-overlapping windings
12 hardening material
13 wires
2 linear motor
20 coil assembly
21a-c overlapping windings
22 magnet track
23 magnet
G gap
1_{EW} length end windings
31a-j concentrated multi-turn coils
31_{E} end winding part
31_{S} straight part
P width of pitch
41a-d concentrated multi-turn coils
5 linear motor
50 coil assembly
51a-k concentrated multi-turn coils
52 housing
53 magnet track
54 magnet
1_{C} coil length
1_{M} magnet length

1-12. (canceled)

13. A linear motor coil assembly, operable in cooperation with an associated magnet track (53), comprising a plurality of concentrated multi-turn coils (31a-f,41a-d,51a-k), wherein each coil of said plurality of coils consists of a coil part (31_{S}) and of end windings (31_{E}), wherein the coil part (31_{S}) between the end windings (31_{E}) of each coil is straight and wherein the coils (31a-f,41a-d,51a-k) are arranged in an overlapping manner, said linear motor coil assembly being characterized in that the overlapping part of the end windings of each coil is substantially flatter than the coil part of each coil.

14. The linear motor coil assembly according to claim 12, wherein the coils (31a-f, 41a-d, 51a-k) are arranged in an overlapping manner such that the space filling in the straight part (31_{S}) of the coil assembly is around 45% or more.

15. A linear motor coil assembly according to claim 12, wherein the coils (31a-f, 41a-d, 51a-k) are encapsulated in a flat housing (52).

16. The linear motor coil assembly according to claim 12, wherein the concentrated multi-turn coils (31a-f, 41a-d, 51a-k) are arranged in an overlapping manner in a single- or multi-layer configuration.

17. The linear motor coil assembly according to claim 12, wherein the concentrated multi-turn coils (31a-f,41a-d,51a-k) have an 0-shape or a hexagonal shape with round edges.

18. A linear motor comprising:
a magnet track (53); and
a coil assembly (50) operating in cooperation with said magnet track (53) and having a plurality of concentrated multi-turn coils (31a-f,41a-d,51a-k), wherein each coil of said plurality of coils consists of a coil part (31_{S}) and of end windings (31_{E}), wherein the coil part (31_{S}) between the end windings (31_{E}) is straight, and wherein the coils (31a-f,41a-d,51a-k) are arranged in an overlapping manner, said coil assembly being characterized in that the overlapping part of the end windings of each coil is substantially flatter than the coil part of each coil.

19. The linear motor according to claim 17, wherein the coils (31a-f,41a-d,51a-k) are arranged in an overlapping manner such that the space filling factor in the straight part (31_{S}) of the coil assembly is around 45% or more.

20. The linear motor according to claim 17, wherein the coils (31a-f,41a-d,51a-k) are encapsulated in a flat housing (52).

21. The linear motor according to claim 17, wherein the height (1_{M}) of the magnets (54) of the magnet track (53) is at least 80% or more of the height (1_{C}) of said concentrated multi-turn coils (31a-f,41a-d,51a-k).

22. The linear motor according to claim 17, wherein the end windings (31_{E}) of the concentrated multi-turn coils (31a-f,41a-d,51a-k) are at least partly situated between the magnets (54) of the magnet track (53).

23. The linear motor according to claim 17, wherein the concentrated multi-turn coils (31a-f,41a-d,51a-k) are arranged in an overlapping manner in a single- or multi-layer configuration.

24. The linear motor according to claim 17, wherein the concentrated multi-turn coils (31a-f,41a-d,51a-k) have an 0-shape or a hexagonal shape with rounded edges.
